(19) United States
(12) Patent Application Publication
(10) Pub. No.: US 2022/0150515 A1
(43) Pub. Date: May 12, 2022

(54) ADAPTIVE TEMPORAL FILTER FOR AN UNAVAILABLE REFERENCE PICTURE

(71) Applicant: OP Solutions, LLC, Amherst, MA (US)

(72) Inventors: Velibor Adzic, Boca Raton, FL (US); Hari Kalva, BOCA RATON, FL (US); Borivoje Furht, BOCA RATON, FL (US)

(73) Assignee: OP Solutions, LLC, Amherst, MA (US)

(21) Appl. No.: 17/297,120

(22) PCT Filed: Nov. 27, 2019
(86) PCT No.: PCT/US19/63707

§ 371 Date: May 26, 2021

Related U.S. Application Data
(60) Provisional application No. 62/771,918, filed on Nov. 27, 2018.

(51) Int. Cl. H04N 19/44; H04N 19/105; H04N 19/117; H04N 19/142; H04N 19/176

(52) U.S. Cl. CPC H04N 19/44; H04N 19/105; H04N 19/176; H04N 19/142; H04N 19/117

(57) ABSTRACT

A decoder includes circuitry configured to receive a bitstream, decode a plurality of video frames from the bitstream, determine for a current block of a current frame that a long term reference block update mode is enabled, determine a long term reference block update including pixel values and using the plurality of video frames, and update a portion of a long term reference frame with the long term reference block update. Related apparatus, systems, techniques and articles are also described.

### CROSS-REFERENCE TO RELATED APPLICATIONS

This application claims the benefit priority of International Application No. PCT/US19/63707 filed on Nov. 27, 2019 and entitled “ADAPTIVE TEMPORAL FILTER FOR AN UNAVAILABLE REFERENCE PICTURE,” the entirety of which is incorporated herein by reference, which claims the benefit of priority of U.S. Provisional Patent Application Ser. No. 62/771,918, filed on Nov. 27, 2018, and titled “ADAPTIVE TEMPORAL FILTER FOR AN UNAVAILABLE REFERENCE PICTURE,” which is incorporated by reference herein in its entirety.

### FIELD OF THE INVENTION

The present invention generally relates to the field of video compression. In particular, the present invention is directed to an adaptive temporal filter for an unavailable reference picture.

### BACKGROUND

A video codec can include an electronic circuit or software that compresses or decompresses digital video. It can convert uncompressed video to a compressed format or vice versa. In the context of video compression, a device that compresses video (and/or performs some function thereof) can typically be called an encoder, and a device that decompresses video (and/or performs some function thereof) can be called a decoder.

There can be complex relationships between the video quality, the amount of data used to represent the video (e.g., determined by the bit rate), the complexity of the encoding and decoding algorithms, sensitivity to data losses and errors, ease of editing, random access, end-to-end delay (e.g., latency), and the like.

Motion compensation can include an approach to predict a video frame or a portion thereof given a reference frame, such as previous and/or future frames, by accounting for motion of the camera and/or objects in the video. It can be employed in the encoding and decoding of video data for video compression, for example in the encoding and decoding using the Motion Picture Experts Group (MPEG)-2 (also referred to as advanced video coding (AVC) and H.264) standard. Motion compensation can describe a picture in terms of the transformation of a reference picture to the current picture. The reference picture can be previous in time when compared to the current picture, from the future when compared to the current picture, or can include a long term reference (LTR) frame. When images can be accurately synthesized from previously transmitted and/or stored images, compression efficiency can be improved.

Current standards such as H.264 and H.265 allow updating of reference frames such as long term reference frames by signaling a newly decoded frame to be saved and made available as a reference frame. Such updates are signaled by the encoder and an entire frame is updated. But updating the entire frame can be costly, particularly where only a small portion of the static background has changed. Partial frame updates are possible but can often involve complex and computationally costly procedures to affect the frame updates. Moreover, such updating can generally involve copying a portion of the current frame to the frame when a portion of the background changes, which may require frequent updates and may not reflect future frame backgrounds, resulting in relatively poorer bit rate performance.

### SUMMARY OF THE DISCLOSURE

In an aspect, a decoder includes circuitry configured to receive a bitstream, decode a plurality of video frames from the bitstream, determine for a current block of a current frame of the plurality of video frames that an unavailable reference block update mode is enabled, determine an unavailable reference block update including pixel values and using the plurality of video frames, and update a portion of an unavailable frame with the unavailable reference block update.

In another aspect, a method includes receiving a bitstream, decoding a plurality of video frames from the bitstream, determining for a current block of a current frame of the plurality of video frames that an unavailable reference block update mode is enabled, determining an unavailable reference block update including pixel values and using the plurality of video frames, and updating a portion of an unavailable reference frame with the unavailable reference block update.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a process flow diagram illustrating an example process of updating a portion (e.g., block) of an unavailable reference frame using multiple video frames;

FIG. 2 illustrates two example unavailable reference frame buffers, one for continuous mode and one for reset mode;

FIG. 3 is a process flow diagram illustrating an example process using continuous mode according to some implementations of the current subject matter;

FIG. 4 is a process flow diagram illustrating an example process using reset mode according to some implementations of the current subject matter;

FIG. 5 is a process flow diagram illustrating an example process of updating an unavailable reference frame using a temporal filter according to some aspects of the current subject matter;

FIG. 6 is a system block diagram illustrating an example decoder capable of decoding a bitstream with unavailable reference frame block updates;

FIG. 7 is a process flow diagram illustrating an example process of encoding a video with unavailable reference frame block updates using multiple frames according to some aspects of the current subject matter that can increase compression efficiency;

FIG. 8 is a system block diagram illustrating an example video encoder capable of signaling for decoder side unavailable reference frame block updates using multiple frames; and

FIG. 9 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

Embodiments described in this disclosure involve receipt, updating, and manipulation of unavailable reference frames. An unavailable reference (UR) frame is a frame and/or picture used to create predicted frames and/or pictures in one or more groups of pictures (GOP), but which is not itself displayed in a video picture. A frame marked as an UR frame in a video bitstream may be available for use as a reference until it is explicitly removed by bitstream signaling. UR frames may improve prediction and compression efficiency in scenes that have static background over an extended period (e.g., background in a video conference or video of parking lot surveillance). However, overtime, the background of a scene gradually changes (e.g., cars when parked in an empty spot become part of the background scene). Updating an UR frame thus improves compression performance by allowing a better prediction.

Current standards such as H.264 and H.265 allow updating of similar frames, such as LTR frames, by signaling a newly decoded frame to be saved and made available as a reference frame. Such updates are signaled by the encoder and an entire frame is updated. But updating the entire frame can be costly, particularly where only a small portion of the static background has changed.

Some existing compression technologies update frames such as LTR frames frame using portions of only the preceding frame, which can result in decreased prediction performance. Some implementations of the current subject matter include updating a portion (e.g., block) of a LTR frame using multiple video frames. For example, an LTR frame may be updated by applying a temporal filter to a buffer of decoded frames to compute a statistic of co-located pixels. For example, a per-pixel mean, median, and/or mode of multiple decoded frames can be computed and used to update a portion of an LTR frame. In some implementations, the current subject matter can support both a continuous mode and a reset mode. By using multiple frames to update a frame such as UR and/or LTR frame instead of using portions of only the preceding frame, prediction may be improved, which in turn may reduce the residual and improve bit rate performance.

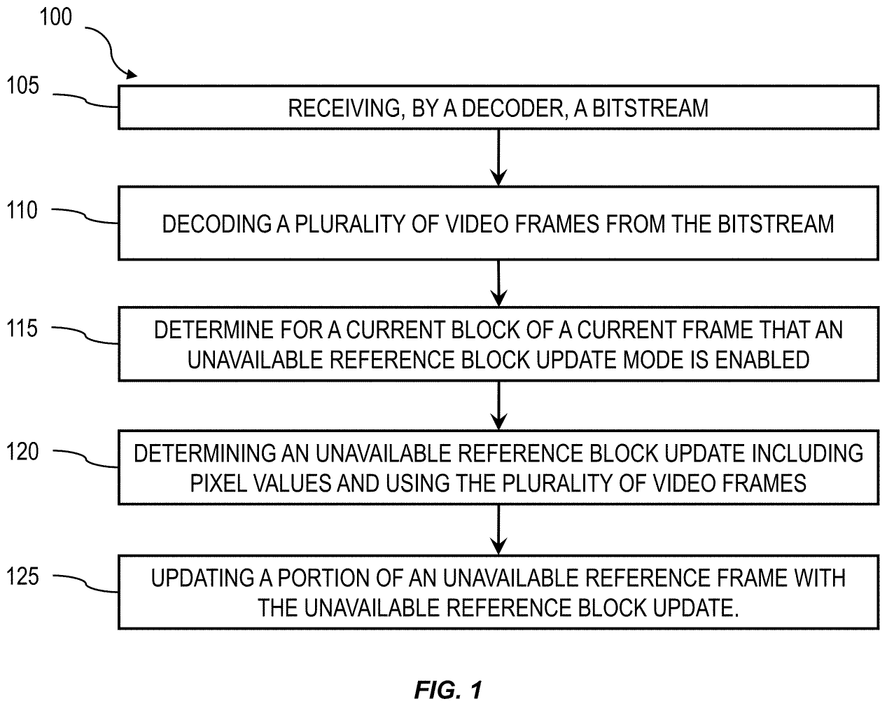

FIG. 1 is a process flow diagram illustrating an example process 100 of updating a portion (e.g., block) of a UR frame using multiple video frames. By using multiple frames to update the UR frame instead of using portions of only the preceding frame, prediction can be improved, which in turn can reduce the residual and improve bit rate performance.

Still referring to FIG. 1, at step 105, a bitstream is received by a decoder. Bitstream may include, for example and without limitation, data found in a stream of bits that is an input to a decoder when using data compression. Bitstream may include information necessary to decode video. Receiving can include extracting and/or parsing blocks and associated signaling information from a bitstream. In some implementations, bit stream may include coded video frames including coded blocks. Each coded block may include a coding tree unit (CTU), a coding unit (CU), and/or a prediction unit (PU).

At step 110, and continuing to refer to FIG. 1, video frames are decoded from (e.g., using) a bitstream. For example, video frames may be decoded by using inter prediction. Decoding via inter prediction may include using a previous frame, a future frame, or a UR frame as a reference for computing a prediction, which may be combined with a residual contained in the bitstream. Other techniques and tools for decoding may be utilized, such as intra prediction.

At step 115, and still referring to FIG. 1, decoder determines whether an unavailable reference block update mode is enabled in the bitstream for a current block. For example, it may be determined that an UR block update mode field in a header of the bitstream is enabled. Signaling of UR frame block updated may be enabled selectively using a header such as a picture parameter set (PPS) or sequence parameter set (SPS). A field, such as UR_BLOCK_UPDATE may take on values of true or false (e.g., 0 or 1); absence of the field in the header can imply a value of false (e.g., 0). In some implementations, an unavailable reference block update mode can be implicitly signaled.

With continued reference to FIG. 1, at 120 decoder determines an unavailable reference block update using video frames. UR block update may include pixel values for modifying a portion of UR frame. Determining unavailable reference block update may include computing a statistic of collocated pixels for the plurality of video frames; for example, the statistic may include a mean, a median, and/or a mode. Statistic may be taken across a set of co-located pixels, such as a set of co-located pixels across multiple frames and/or blocks; as a non-limiting example, an average value of luma and/or chroma of pixels having a given fixed set of coordinates across a set of multiple frames may be calculated, by collecting the chroma and/or luma value of the pixel in each frame at the fixed coordinates, and then calculating the average of the collection of chroma and/or luma values. Statistic may be calculated on one or more attributes of pixels. For example, and without limitation, statistic may be calculated on luma, for instance by calculating a mean, a median, and/or mode of lumas of pixels across one or more video frames of plurality of video frames. As a further non-limiting example, statistic may be calculated on chroma, for instance by calculating a mean, a median, and/or mode of chromas of pixels across one or more video frames of plurality of video frames. In an embodiment, calculation using chromas may be more computationally efficient than calculating by lumas, whereas calculating by lumas may be more accurate than calculating by chromas. In an embodiment, statistic may be used directly to update pixel values in an updated UR frame and/or block; statistic may represent a “closest” representation of a time series of pixels, because it may result in the least amount of residual, as the “average” pixel is statistically most similar to each separate pixel and has the smallest variance therefrom. This may in turn minimize residuals, resulting a higher degree of compression.

A temporal filter operation may be applied to a plurality of video frames, for instance as described in further detail below, to determine the unavailable reference block update.

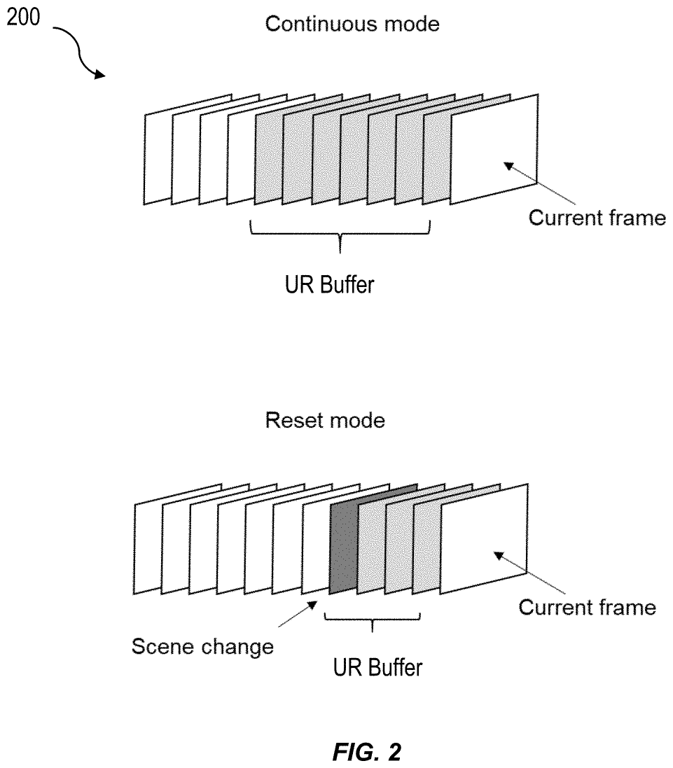

Still referring to FIG. 1, in some implementations, an UR frame buffer may be employed. A UR update may be constructed using operations on frames that are present in UR buffer. UR buffer may include a plurality of frames. For example, FIG. 2 illustrates two exemplary embodiments of UR frame buffers 200, one for continuous mode and one for reset mode.

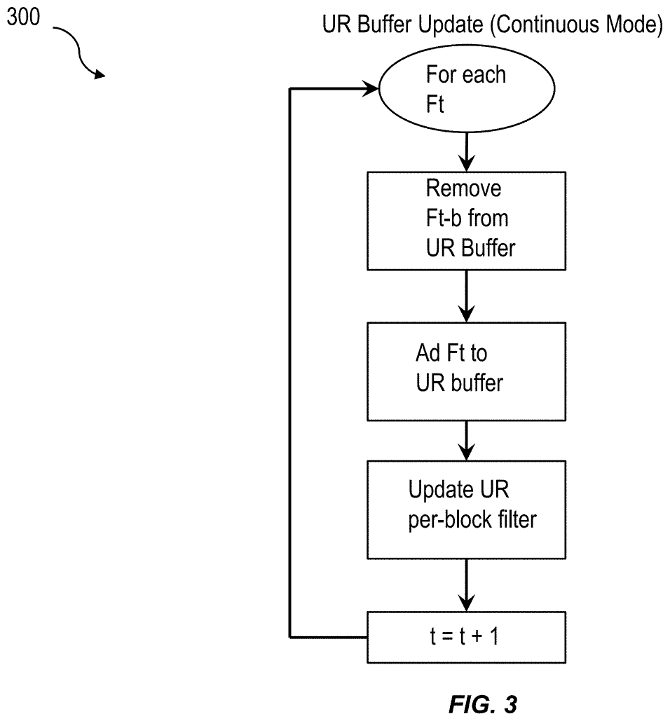

In continuous mode, an example process 300 of which is illustrated at FIG. 3, a UR buffer may be regularly updated by removing a first frame from the buffer and adding a current frame (Ft) to the buffer, similar to a first in first out (FIFO) queue. The current frame can include a newly decoded frame. The buffer may include a predefined length (e.g., predefined maximum number of allowed frames) t-b. A per-block filter may be updated; per-block filter may be any filter suitable for filtering blocks and/or frames as described in this disclosure. Decoder may be configured to determine that unavailable reference buffer has met or exceeds a predefined maximum allowed buffer size, and remove a frame from the unavailable reference buffer. Each current frame as it is processed can be added to the continuous mode buffer and the process can repeat for all frames. In some implementations, continuous mode can be signaled in the bitstream.

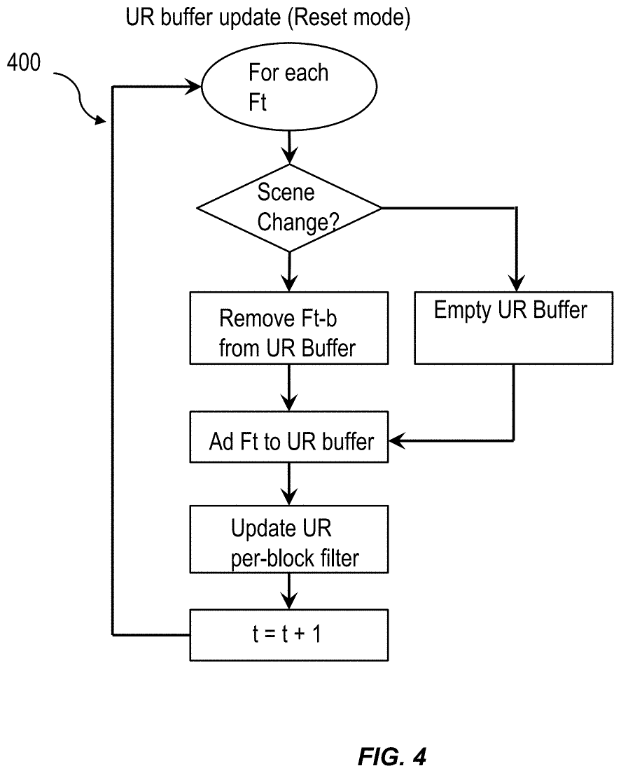

In reset mode, an example process 400 of which is illustrated in FIG. 4, decoder may determine that a reset mode is enabled. A UR buffer may be updated in a similar manner to the above-described continuous mode update, except that when a significant change is detected between two consecutive frames, a scene change may be detected and the UR buffer may be emptied. This determination may be made, for example, by determining an inter-frame similarity between consecutive frames and comparing the similarity to a threshold value. When similarity value is below threshold, a scene change may be detected. When similarity value is above threshold, no scene change may be detected. Persons skilled in the art, upon reviewing the entirety of this disclosure, will be aware of various alternative or additional ways in which such threshold comparisons may be performed, including without limitation by comparison of a difference score to a threshold, where difference above the threshold indicates a scene change whereas difference below the threshold indicates no scene change. In some implementations, a scene reset and/or change may alternatively or additionally be signaled in bitstream. Decoder may clear UR buffer. When UR buffer is cleared, a process of buffer filling can start from a current frame. In some implementations, a reset mode can be signaled in bitstream.

Accordingly, and still referring to FIG. 4, continuous mode may allow for longer buffers and a broader set of reference samples from which to compute a UR frame update. Reset mode may allow for buffer size control based on frame similarity.

As illustrated in FIG. 2, the UR buffer size may become smaller after each scene change in the case of reset mode and subsequently grow to the maximum size of b frames, until a subsequent scene change is encountered.

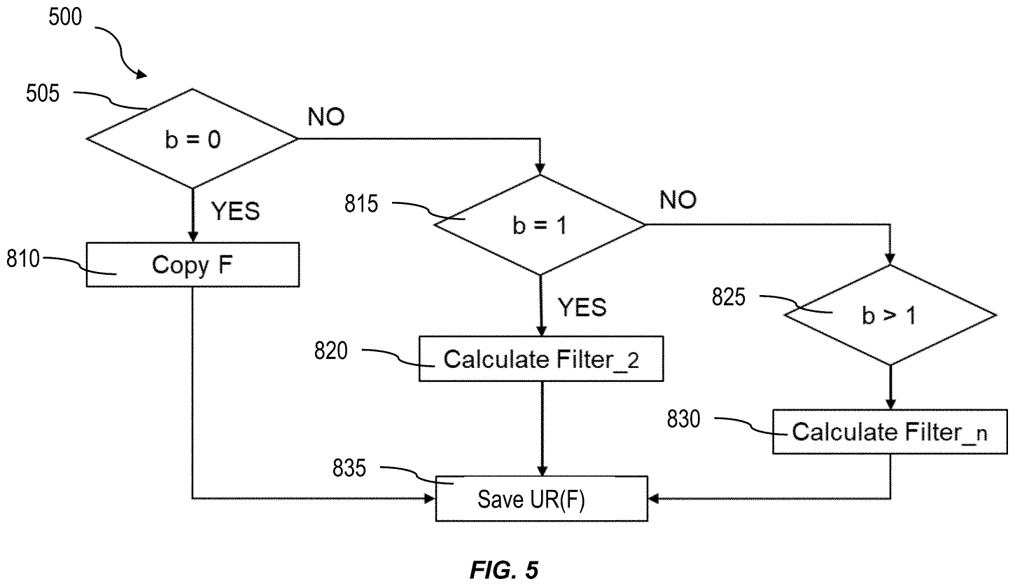

FIG. 5 is a process flow diagram illustrating an exemplary process 500 of updating an UR frame using a temporal filter according to some aspects of the current subject matter. Video frames, having been divided into blocks can be temporally filtered. Each block may have a size of width W and high H, where W may or may not equal H. A filter may be selected from a plurality of filters, which may include without limitation a set of three filters including median, mean, and mode. Updated UR block operation may be implemented, in a non-limiting example, based on a number of frames in buffer. For example, at step 505, it may be determined if there are no frames in the buffer; if so, a UR frame may be constructed by copying, at 510, all blocks from a current frame. At 515, it may be determined if there is one frame in the buffer, and at 520, a UR frame may be constructed by applying a filter operation on matching (e.g., co-located) blocks in a UR buffer frame and the current frame. Such operation may be implemented according to UR(Ft)=Filter 2(UR(Ft−1,Ft)). It may be determined at step 525 if there is more than one frame in the buffer; at step 530, a filter may be applied to a previously calculated UR frame and a current frame according to: UR(Ft)=Filter_n(UR(Ft−1), Ft). At step 535, a UR update (e.g., results of applying a filter as described above) may be saved to a UR frame. In some implementations, a filter operation may be selected based on performance requirements such as processing speed, robustness to quantization and/or word-length limitations, passband and/or stopband distortion and/or ripple, phase change and/or delay characteristics, degree and/or speed of attenuation and/or transition from passband to stopband or vice-versa, or the like, may be signaled in a bitstream, or any other suitable process for filter selection.

In some implementations, and still referring to FIG. 5, update may be enforced on an entire UR frame or on one or more blocks of the UR frame. In some implementations, pixel-by-pixel updates may be possible (e.g., a block may have size 1×1).

Filters may be computed, without limitation, as follows: median filter may be calculated as:

Filter_2median(Px,y,t)=Px,y,t−1

Filter_nmedian(Px,y,t)=median (Px,y,t−1, Px,y,t−1, Px,y,t−n)

where median( ) represents the middle value of the sorted array of numbers. Mean filter may be calculated as:

$$Filter\_ 2 mean ( Px , y , t ) = Px , y , t - 1$$

$$Filter\_nmean ( Px , y , t ) = \frac{{\sum }_{k = 1}^{n} Px , y , k}{n}$$

Mode filter may be calculated as:

Filter_2mode(Px,y,t)=Px,y,t−1

Filter_nmode(Px,y,t)=mode (Px,y,t−1, Px,y,t−1, Px,y,t−n)

where mode( ) represents a most frequent value occurring in a given array of numbers.

Referring again to FIG. 1, at step 125, decoder may update an unavailable reference frame using a determined UR block update. Such updating may include performing UR block updates in which pixels (e.g., luma values) in UR frame that are spatially co-located with a current block for which UR frame block update mode is enabled are updated (e.g., modified) using a determined UR block update (e.g., containing determined pixel values). Pixels may be updated, without limitation, by replacing pixels with co-located pixels from one or more blocks as described above, including a current block, by updating pixel values with values (e.g. chroma and/or luma values) from one or more blocks as described above, including a current block, by replacing and/or updating pixels with and/or using statistical values, such as without limitation averages, calculated for co-located pixels as described above, and/or by replacing and/or updating pixels with and/or using filter outputs, such as temporal filter outputs, as described in this disclosure. In some implementations, updating may include updating a plurality of blocks of UR frame with a plurality of decoded blocks, which may be performed using any methods described above for updating UR frame with decoded current block. Updating may include, without limitation, generation of a block and/or frame of default chroma and/or luma values and replacement and/or updating thereof from one or more decoded blocks using any process and/or process steps described above; updating may include generating the UR frame, which may be accomplished by creating a UR frame of default values and updating the default values as described above.

Still referring to FIG. 1, for subsequent current blocks, an updated UR frame may be utilized as a reference frame for inter prediction. For example, a coded block may be received. Whether an inter prediction mode is enabled for a coded block may be determined. A decoded block may be determined using an updated UR frame as a reference frame and according to an inter prediction mode. For example, decoding via inter prediction may include using an updated UR frame as a reference for computing a prediction, which may be combined with a residual contained in bitstream.

With continued reference to FIG. 1, UR block updates may be available for each current block during a decoding process. In some implementations, UR block updates may be implicitly skipped for intra coded frames. For example, a bitstream can include a second current coded block within a different frame than a first current coded block. A mode of a second current coded block may include intra prediction. An UR block update may be skipped in response to determining that a second current coded block is an intra prediction block. Skipping may include, e.g., not updating a UR frame or determining whether a field such as UR_BLOCK_UPDATE is set in a header.

In some implementations, and with continued reference to FIG. 1, if a UR_BLOCK_UPDATE field in a header is set, decoder may expect explicit block update signaling bits in bitstream. In this approach, a coded block of video may be signaled in a block header of a video bitstream as a block to be updated in a UR frame. In that case, co-located block in a UR frame may be replaced by results of temporally filtering a frame buffer. This updated UR frame may be used for future motion estimation purposes until the UR frame is subsequently updated, as a non-limiting example.

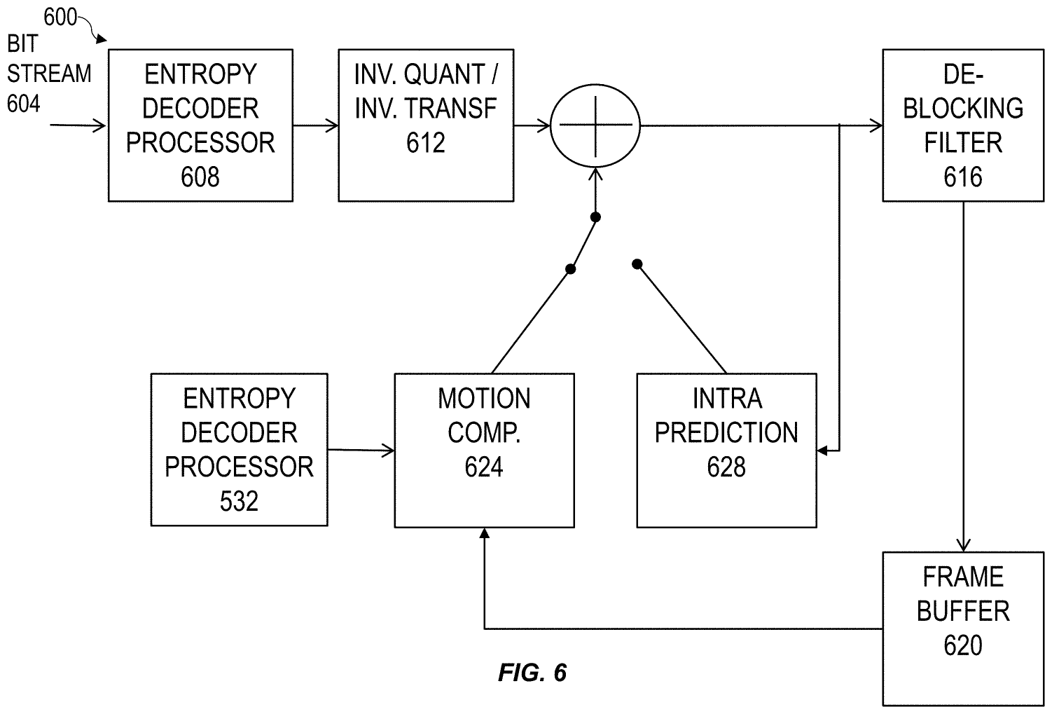

FIG. 6 is a system block diagram illustrating an example decoder 600 capable of decoding a bitstream 604 with UR frame block updates. Decoder 600 may include an entropy decoder processor 608, an inverse quantization and inverse transformation processor 612, a deblocking filter 616, a frame buffer 620, motion compensation processor 624 and intra prediction processor 628. In some implementations, bitstream 604 includes parameters (e.g., field in a header of the bitstream) that signal a UR frame block update mode. Motion compensation processor 624 may reconstruct pixel information using UR frame and update the UR frame according to a UR frame block update mode and using multiple frames. For example, when a UR frame block update mode is explicitly signaled for a current block, co-located pixels (e.g., luma values) in a UR frame can be replaced with pixel values computed by applying a temporal filter to frames within a UR frame buffer. Such updating may include performing UR block updates in which pixels in UR frame that are spatially co-located with a current block are updated (e.g., modified) using the decoded current block. In some implementations, block update mechanisms may be explicit or implicit. For example, a portion of (e.g., a block of) UR frame can be updated by updating co-located pixels (e.g., luma values) in UR frame with pixel values of decoded current block; in other words, updating UR frame may include replacing luma values of the UR frame with spatially co-located luma values of the decoded current block. In some implementations, UR frame may be updated according to another mechanism, such as updating a portion of the UR frame with an average of initial co-located UR frame pixel values and/or current decoded block pixel values. In an embodiment, each pixel being updated may be replaced and/or updated with a corresponding filter output, such as a result of filtering a set of co-located pixels. Persons skilled in the art, upon reviewing the entirety of this disclosure, will be aware various other mechanisms that may be employed. In some implementations, updating may include updating a plurality of blocks of UR frame with a plurality of decoded blocks, which may be performed using any methods described above for updating UR frame with decoded current block. In some implementations, updating may include updating a plurality of blocks of UR frame with a plurality of decoded blocks, which may be performed using any methods described above for updating UR frame with decoded current block. Updating may include, without limitation, generation of a block and/or frame of default chroma and/or luma values and replacement and/or updating thereof from one or more decoded blocks using any process and/or process steps described above; updating may include generating the UR frame, which may be accomplished by creating a UR frame of default values and updating the default values as described above.

In operation, and still referring to FIG. 6, bit stream 604 may be received by decoder 600 and input to entropy decoder processor 608, which entropy decodes bit stream 604 into quantized coefficients. Quantized coefficients may be provided to inverse quantization and inverse transformation processor 612, which may perform an inverse quantization and/or inverse transformation to create a residual signal, which may be added to an output of motion compensation processor 624 or intra prediction processor 628 according to a processing mode. Output of motion compensation processor 624 and/or intra prediction processor 628 may include a block prediction based on a previously decoded block or UR frame. A sum of a prediction and residual may be processed by deblocking filter 616 and stored in a frame buffer 620. For a given block, (e.g., CU or PU), when bit stream 604 explicitly signals that UR frame block update mode is enabled, motion compensation processor 624 may update a UR frame, which may be included in frame buffer 620, to update co-located pixels (e.g., luma values) in the UR frame with pixel values computed from multiple frames (e.g., frames contained in the frame buffer 620). Pixel values (e.g., UR block update) may be determined by applying a temporal filter to frames in frame buffer 620. Temporal filter may alternatively or additionally be applied to blocks of a video frame, for instance after segmentation to compute unavailable reference block update; as a non-limiting example, one or more pixels and/or blocks may be replaced and/or updated by blocks and/or pixels output by temporal filter.

In some implementations, and continuing to refer to FIG. 6, a decoder 600 may include a UR frame block update processor 632 that generates a UR frame update based on a current block and provides UR frame pixel values for inter prediction processes. UR frame block update processor 632 may directly influence motion compensation. Further, UR frame update processor 632 may receive information from intra-prediction processor, such as when a current block is an intra prediction block.

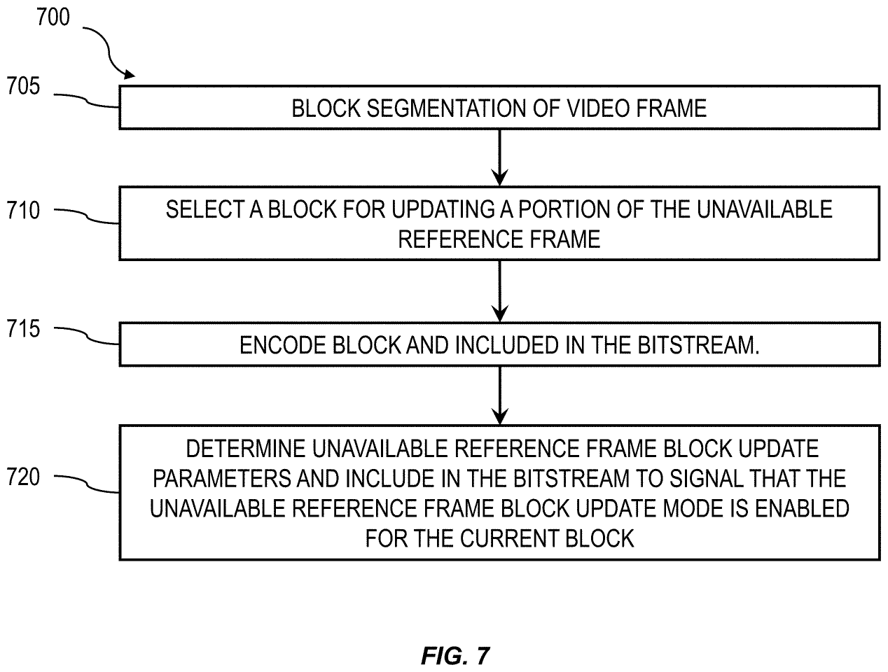

FIG. 7 is a process flow diagram illustrating an exemplary embodiment of a process 700 of encoding a video with UR frame block updates using multiple frames according to some aspects of the current subject matter that can increase compression efficiency. At step 705, a video frame may undergo initial block segmentation, for example, using a tree-structured macro block partitioning scheme that may include partitioning a picture frame into CTUs and CUs. At step 710, a block may be selected for updating a portion of the UR frame. Block may be selected, for example, based on a frequency content and/or measure of motion within the block as compared to one or more co-located blocks that are temporally proximal (e.g., temporally adjacent frames, such as within a predetermined number of frames of a current frame). Selection may include identifying according to a metric rule that block is to be used for updating a portion of a UR frame at a decoder. At step 715, a block may be encoded and included in a bitstream. In some implementations, an encoder side UR frame may be updated using multiple frames, for example, by applying a temporal filter to frames within a frame buffer. An encoder side UR frame may be used for motion estimation and compensation in encoder.

At step 720, and still referring to FIG. 7, explicit UR frame block update parameters may be determined and included in a bitstream to signal that a UR frame block update mode is enabled for a current block. For example, a field in a PPS or SPS may be set (e.g., enabled). For example, a field such as a UR_BLOCK_UPDATE field may be set indicating for a current block that UR frame block update mode is enabled.

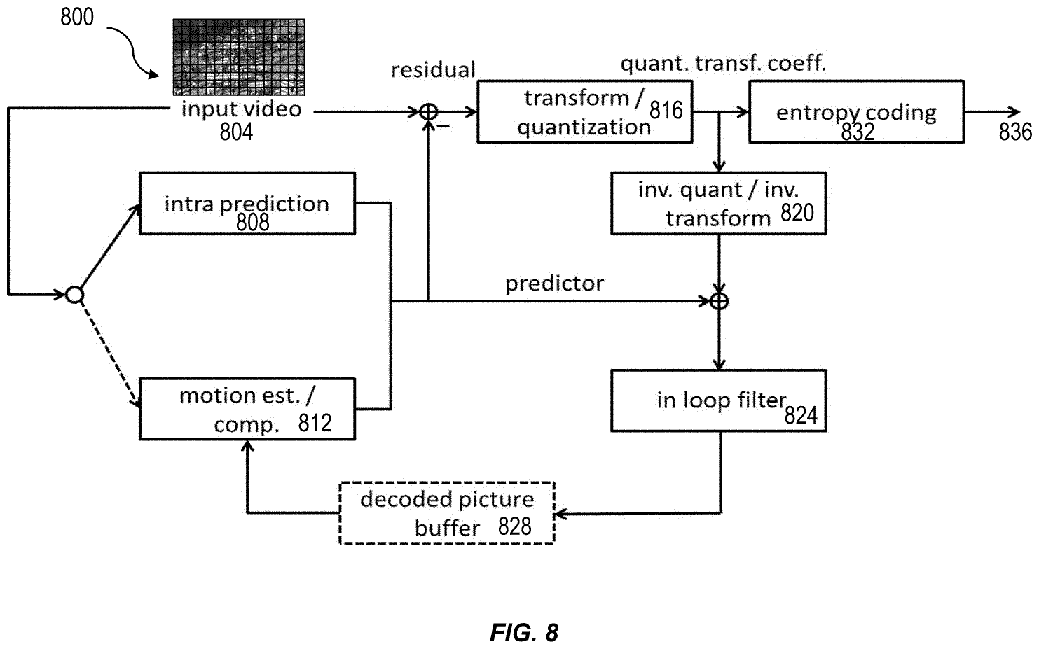

FIG. 8 is a system block diagram illustrating an exemplary embodiment of a video encoder 800 capable of signaling for decoder side UR block updates using multiple frames. Video encoder 800 may receive an input video 804, which may be initially segmented or dividing according to a processing scheme, such as a tree-structured macro block partitioning scheme (e.g., quad-tree plus binary tree). An example of a tree-structured macro block partitioning scheme may include partitioning a picture frame into large block elements called coding tree units (CTU). In some implementations, each CTU may be further partitioned one or more times into a number of sub-blocks called coding units (CU). A final result of this portioning may include a group of sub-blocks that may be called predictive units (PU). Transform units (TU) may also be utilized.

Still referring to FIG. 8, example video encoder 800 may include an intra prediction processor 808, a motion estimation/compensation processor 812 (also referred to as an inter prediction processor) capable of supporting UR frame block updates at a decoder, a transform/quantization processor 816, an inverse quantization/inverse transform processor 820, an in-loop filter 824, a decoded picture buffer 828, and an entropy coding processor 832. In some implementations, motion estimation/compensation processor 812 may determine for a current block that a UR frame should be updated at a decoder and set parameters to explicitly signal that an UR frame block update mode is enabled. In some implementations, implicit signaling may be performed. Bit stream parameters that signal UR frame block update modes may be input to entropy coding processor 832 for inclusion in an output bit stream 836. A portion of an encoder side UR frame may be updated for use by motion estimation/compensation processor 812 for encoding additional blocks that may utilize the UR frame as a reference for inter prediction. An encoder side UR frame may be updated using multiple frames, for example, by applying a temporal filter to frames within a frame buffer.

In operation, for each block of a frame of input video 804, whether to process the block via intra picture prediction or using motion estimation/compensation may be determined. Block may be provided to intra prediction processor 808 or motion estimation/compensation processor 812. If block is to be processed via intra prediction, intra prediction processor 808 may perform the processing to output a predictor. If block is to be processed via motion estimation/compensation, motion estimation/compensation processor 812 may perform processing including using encoder side UR frame as a reference for inter prediction, if applicable.

A residual may be formed by subtracting a predictor from input video; the residual may be received by transform/quantization processor 816, which may perform transformation processing (e.g., discrete cosine transform (DCT)) to produce coefficients, which may be quantized. Quantized coefficients and any associated signaling information may be provided to entropy coding processor 832 for entropy encoding and inclusion in output bit stream 836. Entropy encoding processor 832 may support encoding of signaling information related to UR frame block update modes. In addition, quantized coefficients may be provided to inverse quantization/inverse transformation processor 820, which may reproduce pixels, which may be combined with the predictor and processed by in loop filter 824, an output of which may be stored in decoded picture buffer 828 for use by motion estimation/compensation processor 812 that is capable of supporting UR frame block updates at a decoder. Decoded picture buffer 828 may include a UR frame and motion estimation/compensation processor 812 may utilize the UR frame as a reference for inter prediction. Encoder side UR frame may be updated using multiple frames, for example, by applying a temporal filter to frames within a frame buffer.

With continued reference to FIG. 8, although a few variations have been described in detail above, other modifications or additions are possible. For example, in some implementations, blocks may include any symmetric blocks (8×8, 16×16, 32×32, 64×64, 128×128, and the like) as well as any asymmetric block (8×4, 16×8, and the like).

In some implementations, and still referring to FIG. 8, a quadtree plus binary decision tree (QTBT) may be implemented. In QTBT, at a Coding Tree Unit level, partition parameters of QTBT may be dynamically derived to adapt to local characteristics without transmitting any overhead. Subsequently, at a Coding Unit level, a joint-classifier decision tree structure may eliminate unnecessary iterations and control risk of false prediction. In some implementations, UR frame block update mode may be available as an additional option available at every leaf node of QTBT.

In some implementations, and still referring to FIG. 8 additional syntax elements may be signaled at different hierarchy levels of the bitstream. UR frame block update may be enabled for an entire sequence by including an enable flag coded in a Sequence Parameter Set (SPS). Further, a CTU flag may be coded at a coding tree unit (CTU) level to indicate, whether any coding units (CU) use UR frame block update mode. A CU flag may be coded to indicate whether a current coding unit utilizes UR frame block update mode. Although the above-disclosed embodiments have been described regarding updates to UR frames, the above-disclosed embodiments may alternatively or additionally be applied to other frames, pictures, including without limitation long-term reference frames.

The subject matter described herein provides many technical advantages. For example, some implementations of the current subject matter may improve bit rate of a bitstream by reducing a number of bits required to encode a video. Such improvement may be achieved by improving a UR frame, which in turn may improve prediction and reduce residuals. Further, in some implementations, a UR need not update as frequently, reducing decoder computation requirements. In some implementations, the current subject matter does not increase memory usage because a frame buffer can be utilized by other operations of the encoder and/or decoder. Some implementations of the current subject matter can provide for decoding blocks using an UR frame that can include updating portions of the UR frame without having to update the entire UR frame. Such approaches can reduce complexity while increasing compression efficiency.

It is to be noted that any one or more of the aspects and embodiments described herein may be conveniently implemented using digital electronic circuitry, integrated circuitry, specially designed application specific integrated circuits (ASICs), field programmable gate arrays (FPGAs) computer hardware, firmware, software, and/or combinations thereof, as realized and/or implemented in one or more machines (e.g., one or more computing devices that are utilized as a user computing device for an electronic document, one or more server devices, such as a document server, etc.) programmed according to the teachings of the present specification, as will be apparent to those of ordinary skill in the computer art. These various aspects or features may include implementation in one or more computer programs and/or software that are executable and/or interpretable on a programmable system including at least one programmable processor, which may be special or general purpose, coupled to receive data and instructions from, and to transmit data and instructions to, a storage system, at least one input device, and at least one output device. Appropriate software coding may readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, Programmable Logic Devices (PLDs), and/or any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

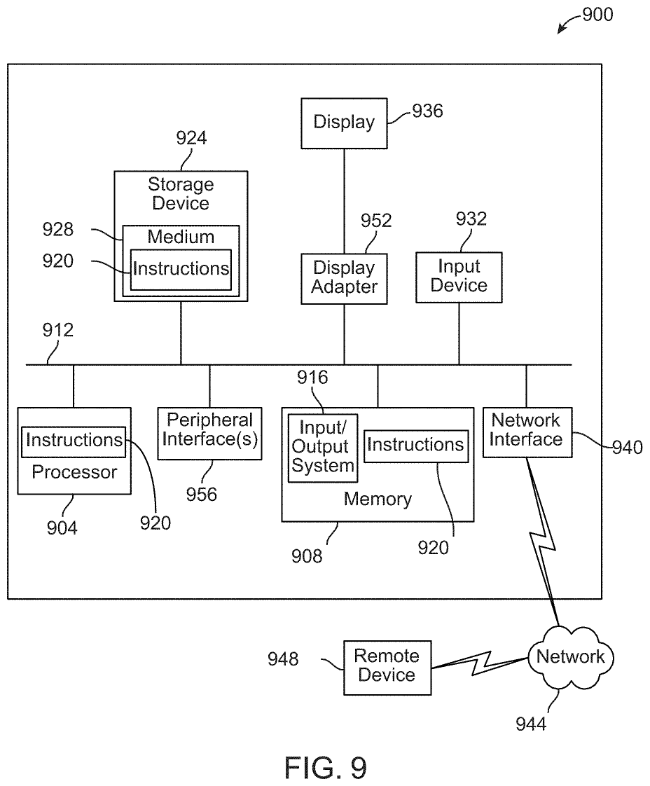

FIG. 9 shows a diagrammatic representation of one embodiment of a computing device in the exemplary form of a computer system 900 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 900 includes a processor 904 and a memory 908 that communicate with each other, and with other components, via a bus 912. Bus 912 may include any of several types of bus structures including, but not limited to, a memory bus, a memory controller, a peripheral bus, a local bus, and any combinations thereof, using any of a variety of bus architectures.

Memory 908 may include various components (e.g., machine-readable media) including, but not limited to, a random-access memory component, a read only component, and any combinations thereof. In one example, a basic input/output system 916 (BIOS), including basic routines that help to transfer information between elements within computer system 900, such as during start-up, may be stored in memory 908. Memory 908 may also include (e.g., stored on one or more machine-readable media) instructions (e.g., software) 920 embodying any one or more of the aspects and/or methodologies of the present disclosure. In another example, memory 908 may further include any number of program modules including, but not limited to, an operating system, one or more application programs, other program modules, program data, and any combinations thereof.

Computer system 900 may also include a storage device 924. Examples of a storage device (e.g., storage device 924) include, but are not limited to, a hard disk drive, a magnetic disk drive, an optical disc drive in combination with an optical medium, a solid-state memory device, and any combinations thereof. Storage device 924 may be connected to bus 912 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 924 (or one or more components thereof) may be removably interfaced with computer system 900 (e.g., via an external port connector (not shown)). Particularly, storage device 924 and an associated machine-readable medium 928 may provide nonvolatile and/or volatile storage of machine-readable instructions, data structures, program modules, and/or other data for computer system 900. In one example, software 920 may reside, completely or partially, within machine-readable medium 928. In another example, software 920 may reside, completely or partially, within processor 904.

Computer system 900 may also include an input device 932. In one example, a user of computer system 900 may enter commands and/or other information into computer system 900 via input device 932. Examples of an input device 932 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 932 may be interfaced to bus 912 via any of a variety of interfaces (not shown) including, but not limited to, a serial interface, a parallel interface, a game port, a USB interface, a FIREWIRE interface, a direct interface to bus 912, and any combinations thereof. Input device 932 may include a touch screen interface that may be a part of or separate from display 936, discussed further below. Input device 932 may be utilized as a user selection device for selecting one or more graphical representations in a graphical interface as described above.

A user may also input commands and/or other information to computer system 900 via storage device 924 (e.g., a removable disk drive, a flash drive, etc.) and/or network interface device 940. A network interface device, such as network interface device 940, may be utilized for connecting computer system 900 to one or more of a variety of networks, such as network 944, and one or more remote devices 948 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 944, may employ a wired and/or a wireless mode of communication. In general, any network topology may be used. Information (e.g., data, software 920, etc.) may be communicated to and/or from computer system 900 via network interface device 940.

Computer system 900 may further include a video display adapter 952 for communicating a displayable image to a display device, such as display device 936. Examples of a display device include, but are not limited to, a liquid crystal display (LCD), a cathode ray tube (CRT), a plasma display, a light emitting diode (LED) display, and any combinations thereof. Display adapter 952 and display device 936 may be utilized in combination with processor 904 to provide graphical representations of aspects of the present disclosure. In addition to a display device, computer system 900 may include one or more other peripheral output devices including, but not limited to, an audio speaker, a printer, and any combinations thereof. Such peripheral output devices may be connected to bus 912 via a peripheral interface 956. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve embodiments as disclosed herein. Accordingly, this description is meant to be taken only by way of example, and not to otherwise limit the scope of this invention.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A decoder, the decoder comprising circuitry configured to:
receive a bitstream;
decode a plurality of video frames from the bitstream;
determine for a current block of a current frame that a unavailable reference block update mode is enabled;
determine an unavailable reference block update including pixel values and using the plurality of video frames; and
update a portion of an unavailable frame with the unavailable reference block update.

2. The decoder of claim 1, wherein determining the unavailable reference block update includes computing a statistic of collocated pixels for the plurality of video frames.

3. The decoder of claim 2, wherein the statistic includes a mean, a median, and/or a mode.

4. The decoder of claim 1, wherein determining the unavailable reference block update includes applying a temporal filter operation to the plurality of video frames.

5. The decoder of claim 1, further configured to determine a unavailable reference buffer including the plurality of frames, decode a new frame, and add the new frame to the unavailable reference buffer.

6. The decoder of claim 5, further configured to determine that a reset mode is enabled, receive a scene change signal, and clear the long term frame buffer.

7. The decoder of claim 5, further configured to determine that a reset mode is enabled, detect a scene change, and clear the unavailable reference frame buffer.

8. The decoder of claim 5, further configured to determine that the unavailable reference buffer has met or exceeds a predefined maximum allowed buffer size, and remove a frame from the unavailable reference buffer.

9. The decoder of claim 1, further configured to segment each video frame into blocks, and apply a temporal filter to the blocks of the video frames to compute the unavailable reference block update.

10. The decoder of claim 1, further configured to decode a new frame, wherein the determining the unavailable reference block update includes using the unavailable reference frame and the new frame.

11. The decoder of claim 1, further comprising:
an entropy decoder processor configured to receive the bit stream and decode the bitstream into quantized coefficients;
an inverse quantization and inverse transformation processor configured to process the quantized coefficients including performing an inverse discrete cosine;
a deblocking filter;
a frame buffer; and
an intra prediction processor.

12. A method comprising:
receiving a bitstream;
decoding a plurality of video frames from the bitstream;
determining for a current block of a current frame that an unavailable reference block update mode is enabled;
determining an unavailable reference block update including pixel values and using the plurality of video frames; and
updating a portion of an unavailable reference frame with the unavailable reference block update.

13. The method of claim 12, wherein determining the unavailable reference block update includes computing a statistic of collocated pixels for the plurality of video frames.

14. The method of claim 13, wherein the statistic includes a mean, a median, and/or a mode.

15. The method of claim 12, wherein determining the unavailable reference block update includes applying a temporal filter operation to the plurality of video frames.

16. The method of claim 12, further comprising:
determining an unavailable reference buffer including the plurality of frames;
decoding a new frame; and
adding the new frame to the unavailable reference buffer.

17. The method of claim 16, further comprising:
determining that a reset mode is enabled;
receiving a scene change signal; and
clearing the unavailable reference buffer.

18. The method of claim 16, further comprising:
determining that a reset mode is enabled;
detecting a scene change; and
clearing the unavailable reference buffer.

19. The method of claim 16, further comprising:
determining that the unavailable reference buffer has met or exceeds a predefined maximum allowed buffer size; and
removing a frame from the unavailable reference buffer.

20. The method of claim 12, further comprising:
segmenting each video frame into blocks; and
applying a temporal filter to the blocks of the video frames to compute the unavailable reference block update.

21. The method of claim 12, further comprising decoding a new frame, wherein the determining the unavailable reference block update includes using the unavailable reference frame and the new frame.

22. The method of claim 12, the decoder further comprising:
an entropy decoder processor configured to receive the bit stream and decode the bitstream into quantized coefficients;
an inverse quantization and inverse transformation processor configured to process the quantized coefficients including performing an inverse discrete cosine;
a deblocking filter;
a frame buffer; and
an intra prediction processor.
